(19) United States
(12) Patent Application Publication
(10) Pub. No.: US 2012/0254552 A1
(43) Pub. Date: Oct. 4, 2012

(54) Memory access remapping

(75) Inventors: Man Cheung Joseph Yiu, Cambridge (GB); Simon John Craske, Cambridge (GB)

(73) Assignee: ARM LIMITED, Cambridge (GB)

(21) Appl. No.: 13/064,528

(22) Filed: Mar. 30, 2011

(51) Int. Cl. G06F 12/00

(52) U.S. Cl. 711/154; 711/E12.001

(57) ABSTRACT

A data processing system is provided comprising a bus master coupled to a bus slave via a bus system. The bus master is configured to access the bus slave by issuing an access request, the access request being routed by the bus system to the bus slave.

The bus system comprises a data processing apparatus configured to act as an intermediary within the bus system. The intermediary data processing apparatus comprises an input configured to receive the access request issued by the bus master, the access request specifying a memory address in the bus slave; an address comparator configured to determine an alias condition to be true if the memory address is within a predefined aliased memory region; an address remapper configured, if the alias condition is true, to remap the memory address into an associated target memory address and a bit position within a target data value stored at the associated target memory address; a request issuer configured to issue a remapped access request, the remapped access request causing the target data value to be read from the associated target memory address and to be returned to the data processing apparatus; and a data handler configured to perform a data processing operation on the target data value at the bit position.

### BACKGROUND OF THE INVENTION

1. Field of the Invention

The present invention relates to data processing systems in which a bus master is configured to access a bus slave by issuing an access request, the access request specifying a memory address in the bus slave. In particular the present invention is concerned with data processing systems in which the memory address may be remapped.

2. Description of the Prior Art

Data processing systems are typically configured to allow access to an associated memory by means of memory addresses, wherein a given memory address will typically identify a number of data values. For example, an individual memory address may identify a single byte of storage, although other arrangements, such as word-addressable memories are also known.

Whilst this arrangement is generally beneficial in terms of the efficient movement of larger quantities of data to and from the memory, there may be situations when it is desirable to be able to access (either reading from or writing to) an individual bit within the memory.

Accordingly, it is known to provide a processor unit with the ability to remap a predetermined set of memory addresses as references to individual bits in a predetermined “bit-band” region of memory. For example the Cortex-M3 processors provided by ARM Limited, Cambridge, UK include this functionality (see the “Cortex-M3 Technical Reference Manual”, retrievable at http://infocenter.arm.com/help/topic/com.arm.doc.ddi0337-/. However, providing the ability to remap bit-band alias addresses to a bit-band region of memory within a processor unit costs valuable area within the processor and limits the availability of this feature to processor units which are so configured. Accordingly, it would be desirable to provide a more flexible technique for allowing bit-band remapping within a data processing system.

### SUMMARY OF THE INVENTION

Viewed from a first aspect the present invention provides a data processing system comprising a bus master coupled to a bus slave via a bus system, wherein said bus master is configured to access said bus slave by issuing an access request, said access request being routed by said bus system to said bus slave, wherein said bus system comprises a data processing apparatus configured to act as an intermediary within said bus system, said data processing apparatus comprising: an input configured to receive said access request issued by said bus master, said access request specifying a memory address in said bus slave; an address comparator configured to determine an alias condition to be true if said memory address is within a predefined aliased memory region; an address remapper configured, if said alias condition is true, to remap said memory address into an associated target memory address and a bit position within a target data value stored at said associated target memory address; a request issuer configured to issue a remapped access request, said remapped access request causing said target data value to be read from said associated target memory address and to be returned to said data processing apparatus; and a data handler configured to perform a data processing operation on said target data value at said bit position.

The present technique recognises that a more flexible data processing system is provided if an intermediate device (a data processing apparatus) within the bus system is provided which is configured to perform bit-band remapping. This intermediate device is configured to receive an access request issued by a bus master within the data processing system and, if that access request specifies a memory address within a predefined alias memory region, to remap the memory address into an associated target memory address and a bit position within the data value stored at that associated target memory address. The intermediate device then issues a remapped access request to cause that target data value to be read from the associated target memory address. A data handler within the intermediate device then performs a data processing operation with respect to the target data value at the given bit position. Since the intermediate device may be positioned at a number of locations within the bus system, this results in a more efficient use of resources within the data processing system. For example, the intermediate device may be positioned within the bus system such that access requests issued by a number of bus masters can benefit from the bit-band remapping facility that it provides. Furthermore, some of these bus masters may not be processor units which might otherwise have individually been provided with such bit-band remapping functionality, for example the bus master could be a DMA controller. Also, the intermediate device may be positioned within the bus system such that its effect on the timings of memory access requests being passed around the system is limited to those where it is necessary. For example, the intermediate device may be positioned between a common bus in the data processing system and a set of peripheral devices which contain the target memory addresses. This then means that other memory access requests going to other areas of the memory map need not interact with this intermediate device.

The data processing apparatus may handle both read access requests and write access requests directed to the bit-band region. Accordingly, in one embodiment if said access request is a read access request, said data processing operation is a bit read operation configured to read a bit value at said bit position; and said data processing apparatus is configured to return said bit value to said bus master. The data processing apparatus is thus configured to identify the bit value at the bit position within the target data value and to return this to the bus master which issued the access request pertaining to that bit value.

It will be appreciated that there are a number of ways in which the data processing apparatus could be configured to pass a read bit value back to the bus master, and in one embodiment said data processing apparatus is configured to return said bit value to said bus master by returning a read data value to said bus master, wherein said bit value is specified at a predetermined bit position in said read data value. This allows the usual bus transaction protocols within the data processing system for transferring data on the bus to be used and thereby to efficiently return the bit value to the bus master.

In one such embodiment said data handler comprises a bit shifter configured to perform a bit shift operation on said target data value to align said bit value with said predetermined bit position in said read data value. This enables the data processing system to have a predetermined protocol for transferring the selected bit value, for example always transferring the bit as the least significant bit of the read data value.

On the other hand, if said access request is a write access request, said data processing operation is a bit write operation configured to write a bit value at said bit position to generate a modified target data value; and said request issuer is further configured to issue a write access request after said bit write operation has been performed, said write access request causing said modified target data value to be written at said associated target memory address. Thus when the access request is a write access request, and therefore a bit value should be modified within the. target data value, the data processing apparatus is configured to first read the target data value from the associated target memory address, then to write, the bit value at the bit position, and finally to issue a write access request to return the modified target data value to its storage memory.

In one such embodiment, said access request comprises a write data value and said bit value is specified at a predetermined bit position in said write data value. This arrangement allows the bus master to use the usual bus protocols for data transfer to provide the bit value which should be written by embedding it in a write data value at a predetermined bit position.

In one such embodiment said data handler comprises a bit shifter configured to perform a bit shift operation on said write data value to align said bit value with said bit position in said target data value. This enables the data processing apparatus to align the bit value with the specified bit position in the target data value.

In one embodiment said access request issued by said bus master specifies a data size; said address remapper is configured to remap said memory address in dependence on said data size; and said request issuer is configured to issue said remapped access request including said data size. This configuration enables the remapping to be performed appropriately for the data size. For example, where the data size is specified as byte length, a set of eight memory addresses will map into a given target memory address, whereas if the data size is word length, a set of 32 memory addresses may map into a target memory address (where the data processing system has a byte length of eight and a word length of 32). The data size also determines the size of the target data value retrieved by the remapped access request, i.e. the number of bytes accessed by the associated target memory address.

In one embodiment said data processing apparatus is further configured, if said access request is an instruction access request, to transmit said access request unmodified. Since it is typically not desirable for instructions to be modified (whether via bit-band access or not) an access request pertaining to an instruction can be left unmodified by the data processing apparatus. However, it is recognised that there may be circumstances in which an instruction may be stored in a region of memory which is bit band aliased, for example when that region is used for more than one purpose.

A particular advantage of the present technique is the ability for the data processing apparatus to be positioned at a number of positions within the data processing system. In one embodiment, said data processing apparatus is configured to be positioned between said bus master and a common bus of said bus system. This enables the bit-band functionality of the data processing apparatus to be specifically reserved for that bus master. In another embodiment said data processing apparatus is configured to be positioned between a common bus of said bus system and a target device hosting said associated target memory address. This is advantageous because a number of bus masters in the data processing system can then benefit from the bit-band functionality provided by the data processing apparatus. Thus whilst only one instance of the hardware required to provide the bit-band functionality is needed, many masters in the data processing system can benefit from this feature. Furthermore, since the data processing apparatus is positioned between the common bus and the target device hosting the associated target memory address, any delays introduced by the provision of the data processing apparatus (for example by the actions of the address comparator determining if a memory address in a memory access request is within the predefined aliased memory region), these delays are confined to memory access requests being passed to the target device. In another embodiment said data processing apparatus is configured to be positioned between two common buses of said bus system. This advantageously allows any memory access requests being passed from one bus to the other bus to be modified as described above.

In one embodiment said data processing apparatus is configured to indicate success of said data processing operation to said bus master. This helps ensure system reliability by allowing the access request issuing bus master to be notified if the data processing operation performed by the data processing apparatus has been successfully completed. Conversely in one embodiment said data processing apparatus is configured to indicate failure of said data processing operation to said bus master. Similarly, this enables the bus master issuing the access request to be notified if there is a problem with the data processing operation.

It will be recognised that the data processing apparatus could be controlled in a number of ways, but in one embodiment said data processing apparatus comprises a finite state machine configured to control operation of said data processing apparatus. Given the limited number of operations that are required to be performed by the data processing apparatus, a finite state machine represents a reliable mechanism for ensuring that in performing its data processing operations the data processing apparatus is configured in a well defined and predictable manner.

When the access request is a write access request it is desirable to ensure the atomicity of the read-followed-by-write process, and accordingly in one embodiment said request issuer is configured to broadcast a bus master lock when issuing said remapped access request, said bus master lock being asserted until completion of said write access request.

Whilst the bit-band aliased regions of memory may in some circumstances only be accessed by a bit-band-style access, in one embodiment said associated target memory address is also accessible by a non-remapped access request.

In one embodiment said associated target memory address is hosted by a peripheral device, a memory or an I/O device.

In one embodiment said bus master is a processor core.

In one embodiment said bus master is a DMA controller.

Viewed from a second aspect the present invention provides a method of data processing in a data processing system comprising a bus master coupled to a bus slave via a bus system, wherein said bus master is configured to access said bus slave by issuing an access request, said access request being routed by said bus system to said bus slave, wherein said bus system comprises a data processing apparatus configured to act as an intermediary within said bus system, said method comprising the steps of: receiving at said data processing apparatus an access request issued by a bus master, said access request specifying a memory address; determining an alias condition to be true if said memory address is within a predefined aliased memory region; if said alias condition is true, remapping said memory address into an associated target memory address and a bit position within a target data value stored at said associated target memory address; issuing from said data processing apparatus a remapped access request, said remapped access request causing said target data value to be read from said associated target memory address and to be returned to said data processing apparatus; and performing a data processing operation on said target data value at said bit position.

Viewed from a third aspect the present invention provides a data processing system comprising a bus master coupled to a bus slave via a bus system, wherein said bus master is configured to access said bus slave by issuing an access request, said access request being routed by said bus system to said bus slave, wherein said bus system comprises a data processing apparatus configured to act as an intermediary within said bus system, said data processing apparatus comprising: input means for configured to receive an access request issued by a bus master, said access request specifying a memory address; address comparison means for determining an alias condition to be true if said memory address is within a predefined aliased memory region; address remapping means for, if said alias condition is true, remapping said memory address into an associated target memory address and a bit position within a target data value stored at said associated target memory address; request issuing means for issuing a remapped access request, said remapped access request causing said target data value to be read from said associated target memory address and to be returned to said data processing apparatus; and data handling means for performing a data processing operation on said target data value at said bit position.

### BRIEF DESCRIPTION OF THE DRAWINGS

The present invention will be described further, by way of example only, with reference to embodiments thereof as illustrated in the accompanying drawings, in which:

FIG. 1A, FIG. 1B and FIG. 1C schematically illustrate the configurations of data processing systems in three different embodiments;

FIG. 2 schematically illustrates a processor memory map having two separate bit-band regions, each of which is accessed via a dedicated bit-band alias region;

FIG. 3 schematically illustrates how the bit-band aliasing is arranged in one embodiment;

FIGS. 4A and 4B illustrate how a bit-level access may be carried out without bit-band aliasing and with bit-band aliasing;

FIG. 5 schematically illustrates a series of steps taken by a data processing apparatus in one embodiment;

FIG. 6 schematically illustrates the configuration of a data processing apparatus in one embodiment;

FIG. 7A schematically illustrates a state map for the finite state machine shown in FIG. 6; and

FIG. 7B schematically illustrates the timing of various bus transfers in one embodiment.

### DESCRIPTION OF THE PREFERRED EMBODIMENTS

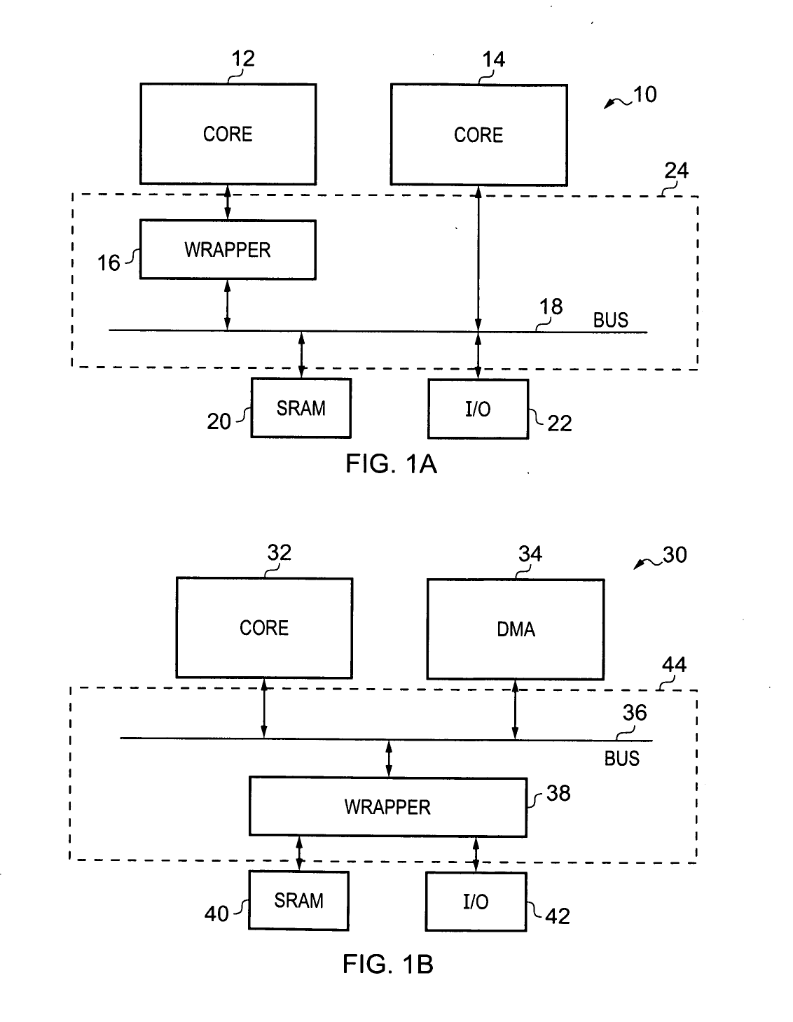

FIG. 1A schematically illustrates a data processing system 10 in one embodiment. The data processing system 10 comprises a processor core 12, a processor core 14, a wrapper 16, a system bus 18, a memory device (SRAM) 20 and an I/O device 22. The processor cores 12 and 14 are configured to perform data processing operations, some of which involve accessing SRAM 20 and I/O device 22. In order to do this, the processor cores 12, 14 act as bus masters, issuing access requests via the bus 18 which passes the access requests appropriately to the SRAM 20 or I/O 22 which act as bus slaves. The bus system 24 comprises the wrapper 16 and the bus 18. The wrapper 16 is configured to monitor the access requests issued by core 12 and (as described in more detail hereinafter) if one of those access requests pertains to a predefined aliased memory region then the wrapper 16 remaps the access request as a bit-band request.

FIG. 1B schematically illustrates a data processing system in, another embodiment. Here the data processing system 30 comprises a processor core 32, a DMA controller 34, a bus 36, a wrapper 38, a memory (SRAM) 40 and an I/O device 42. Hence it can be seen that the bus system 44 illustrated in FIG. 1B is similar to the bus system 24 illustrated in FIG. 1A, except that the wrapper 38 is now positioned between the bus 36 and the peripheral devices 40 and 42. This has the advantage that the bit-banding functionality provided by wrapper 38 can be shared by core 32 and DMA controller 34.

FIG. 1C illustrates yet another example embodiment of a data processing system 50, comprising three processor cores 52, 54, 56. Once more, these bus masters are connected to a memory (SRAM) 60 and I/O 62 via a bus system 64, but here it can be seen that the bus system 64 comprises two common buses 66, 68 wherein a wrapper 58 is positioned between bus 66 and bus 68. This provides an alternative configuration in which processor cores 52 and 54 are provided with the bit-band functionality via wrapper 58 whilst processor core 56 accesses the peripherals 60, 62 directly without this bit-band functionality. When considering the different possibilities presented by the example data processing systems represented in FIGS. 1A, 1B and 1C it can be seen that the system designer is advantageously presented with a choice between providing the bit-band functionality and allowing access requests to pass directly to their target without interaction with the bit-band wrapper. For example in the context of FIG. 1C it can be seen that processor cores 52 and 58 are provided with the functionality of the bit-band wrapper, whilst processor core 56 will be able to access the peripheral devices without the timing delays (although small) which are a consequence of access requests being handled by the bit-band wrapper.

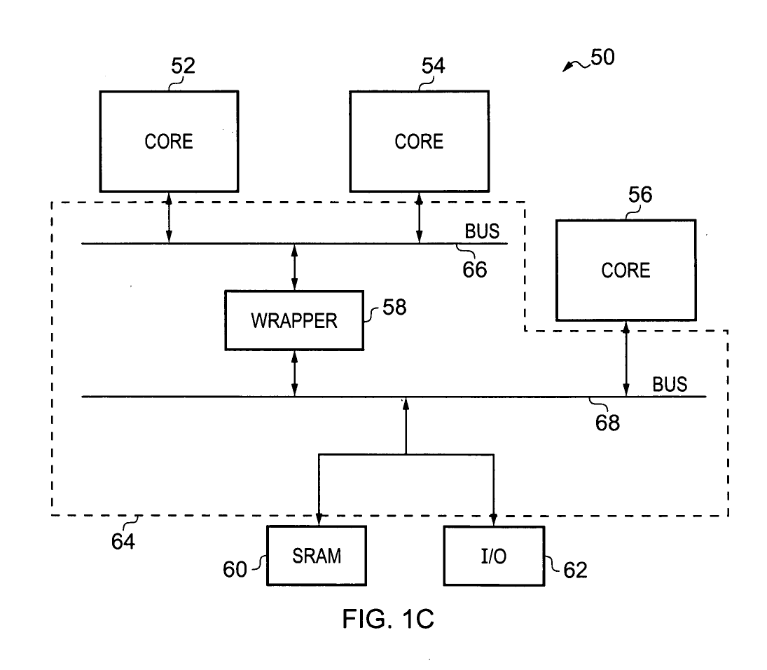

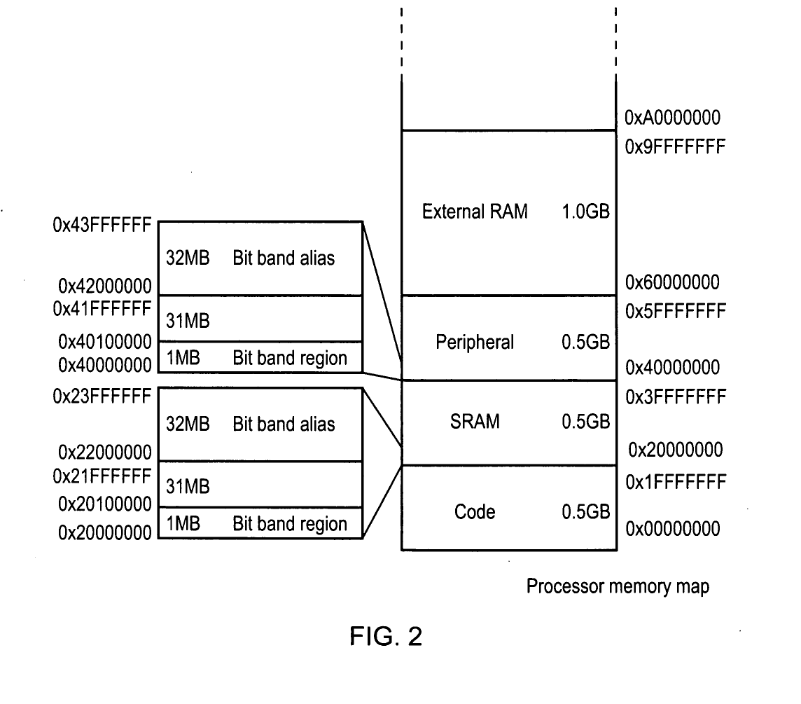

FIG. 2 schematically illustrates an example processor memory map wherein it can be seen that two regions of the memory address regions allocated to the peripheral and the SRAM are used to provide the bit-band functionality. For each, a larger 32 MB region represents the aliased addresses (a predefined aliased memory region), whilst a smaller 1 MB region represents the bit-band region (associated target memory addresses) itself. FIG. 3 schematically illustrates in more detail the mapping of aliased memory addresses in the bit-band alias region into the bit-band region itself. The SRAM example from FIG. 2 is shown as an example. It can be seen that the byte stored at the address 0×20000000 is accessed at its individual bit positions by the set of memory addresses 0×22000000 to 0×2200001C in the aliased region. Similarly, at the upper end of the bit-band region the byte stored at address 0×200FFFFF is accessed at each of its bit positions via the addresses 0×23FFFFEO to 0×23FFFFFC in the aliased region. Hence, the specification of an address in the alias region determines a target address in the bit-band region and a bit position in the byte accessed by that target address. For example, the aliased address 0×23FFFFFC maps to bit position [7] in the byte accessed by target address 0×200FFFFF. Different mappings are of course available and indeed in one embodiment the data size is given as part of an access request specifying a memory address in the aliased region to indicate how the mapping in the bit-band region should be carried out. For example instead of byte length accesses, 32-bit word length accesses can be implemented. An example of this (referring to the addresses used in FIG. 3) would be that, when writing to bit-band alias address 0×22000040 (0×22000000+16*4) with word size, the bit-band wrapper performs a read using the address 0×20000000 with word size (32-bit), sets bit 16 in the value read, and writes that value back. Conversely, if the same operation is carried out with byte size, the bit-band wrapper reads using the address 0×20000002 with byte size (8-bit), sets bit 0 of that byte, and writes back the value to the same byte.

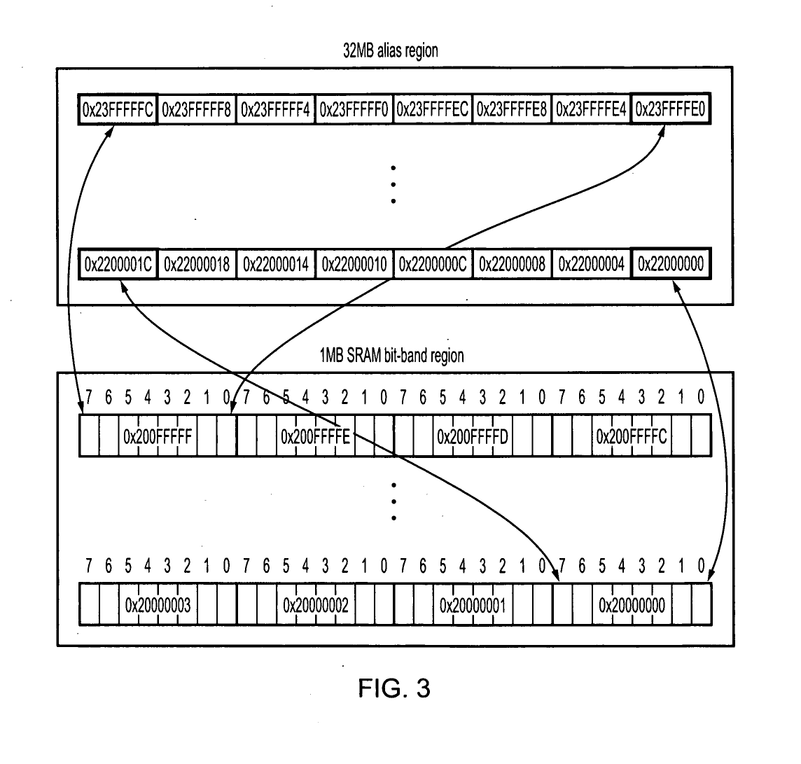

FIG. 4A schematically illustrates a comparison of how individual bit access would happen without the bit-band functionality and how it happens with the bit-band functionality. For example, to set bit 2 in the data value at address 0×20000000, without bit-band functionality three instructions are required: to read the data, to set the bit and then to write back the result. However, with bit-band functionality provided, this task can be carried out by a single instruction, i.e. “write 1 to 0×22000008”, this being mapped into two bus transfers by the bit-band wrapper. Example assembler, sequence for the two alternatives shown in FIG. 4A is shown in FIG. 4B.

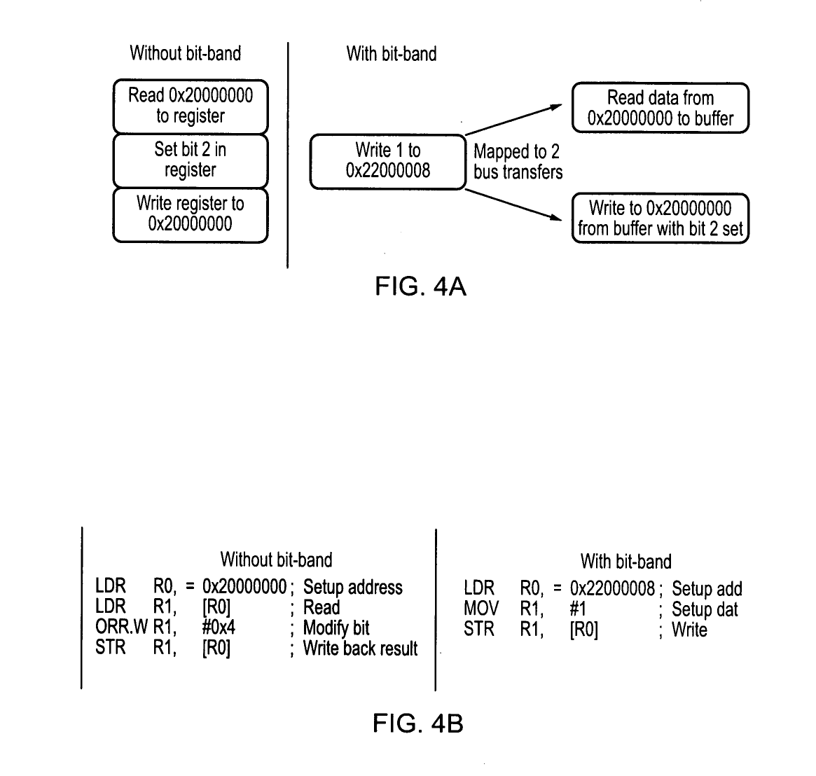

FIG. 5 schematically illustrates a series of steps which may be taken by the bit-band wrapper when an access request is received which has been issued by a bus master. The flow begins at step 100 where an access request (bus transaction) is received by the wrapper. At step 102 it is determined if the address specified in the access request is within an aliased region. If it is not, then the flow proceeds to step 106 and the access request is passed further without further intervention, i.e. a normal access occurs. If however the address is within the aliased region then the flow proceeds to step 104 where it is determined whether the access request pertains to instructions or data. If the memory access request pertains to instructions then the flow also proceeds to step 106 and no further intervention by the bit-band wrapper takes place.

If however the memory access request specifies an address which is in the aliased region and the access request pertains to data, then the flow proceeds to step 108. Here it is determined whether the access request is a read access request or a write access request. If the access request is a read access request then this transaction is identified as a bit-band read (step 110). Then at step 112, the address in the aliased region is remapped to an address in the bit-band region and the corresponding bit-position is determined. Then at step 114 the wrapper issues a corresponding read access request to the bus to retrieve the data value at the remapped memory address.

Note that this access request also specifies the data size. Then at step 116 the wrapper receives the data value read from this remapped memory address and extracts the specified bit from the bit position. Then at step 118 it returns this bit value to the bus master and the flow concludes at step 120. Alternatively, if at step 108 it is determined that the memory access request is a write access request then the transaction is identified as a bit-band write operation (step 112). Then at step 124 the memory address in the aliased region is remapped to a memory address in the bit-band region and the corresponding bit-position is determined. Then at step 126 the wrapper issues a read access request to the bus to retrieve the data values stored at the remapped memory address. Then at step 128 the wrapper bit shifts the data value received from the master as part of the write access request such that the desired bit value aligns with the determined bit position and thus modifies the specified bit within the data value that has been read. Then at step 130 the wrapper issues a write access request onto the bus in order to rewrite this data value at its position in the bit-band region of memory. Finally at step 132 the wrapper signals successful completion of the write process to the bus master and the flow completes at step 120.

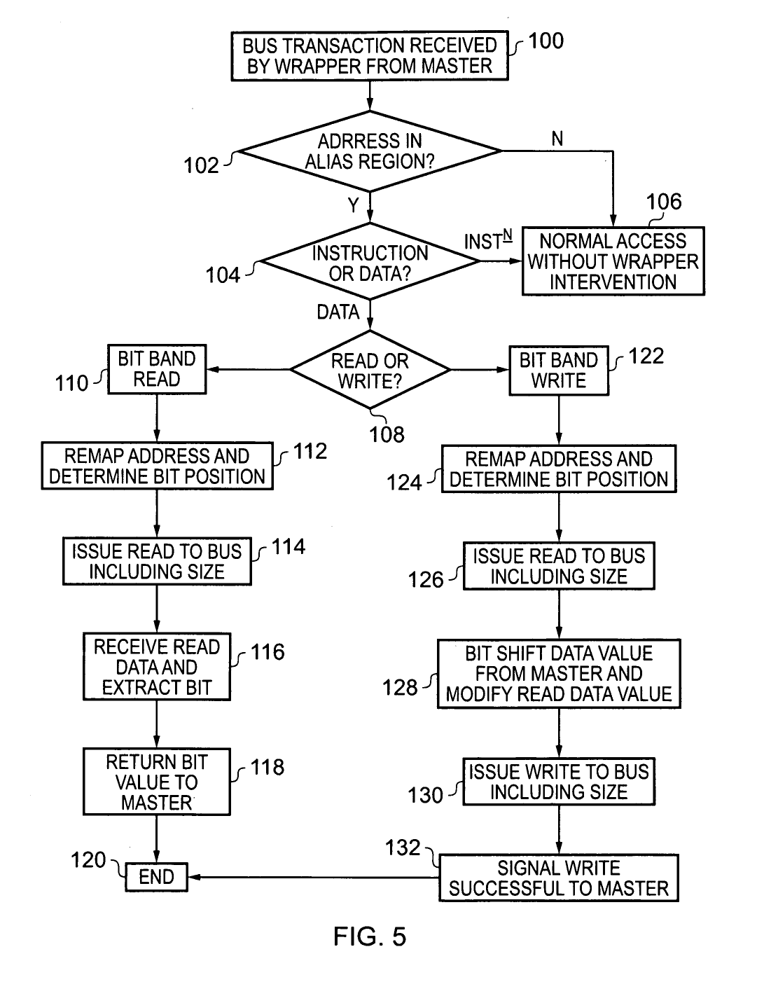

FIG. 6 schematically illustrates the configuration of a bit-band wrapper in one embodiment. Functionally the bit-band wrapper 200 is configured to receive various information such as a data value, an address, the data value size, an indication of whether the access request is instruction-related or data-related and an indication of whether the access request is a read or a write access request. The bit-band wrapper comprises an address comparator 202 configured to determine if the received address corresponds to the bit-band aliased region of memory, and further comprises an address remapper 204 configured to convert the aliased bit-band address into an address in the bit-band region. The data wrapper also comprises a storage unit (e.g. a register) 206 in which the identified bit position is temporarily stored, as well as a data buffer 208 which can hold a data value retrieved from the bit-band region, or to be written back to the bit-band region. Furthermore, the bit-band wrapper 200 comprises a finite state machine 210 which controls the operation of the bit-band wrapper and a data handler 212 which can perform a data processing operation on the data value held in the data buffer 208.

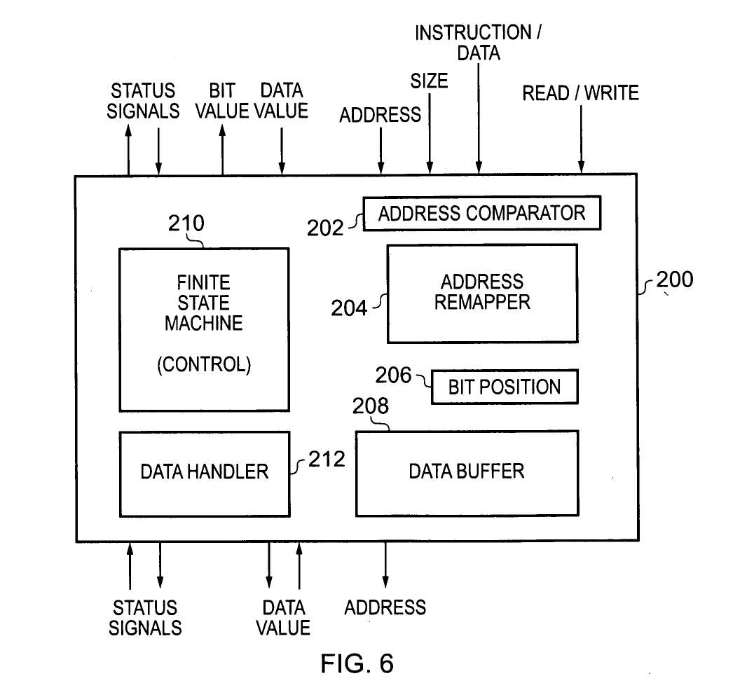

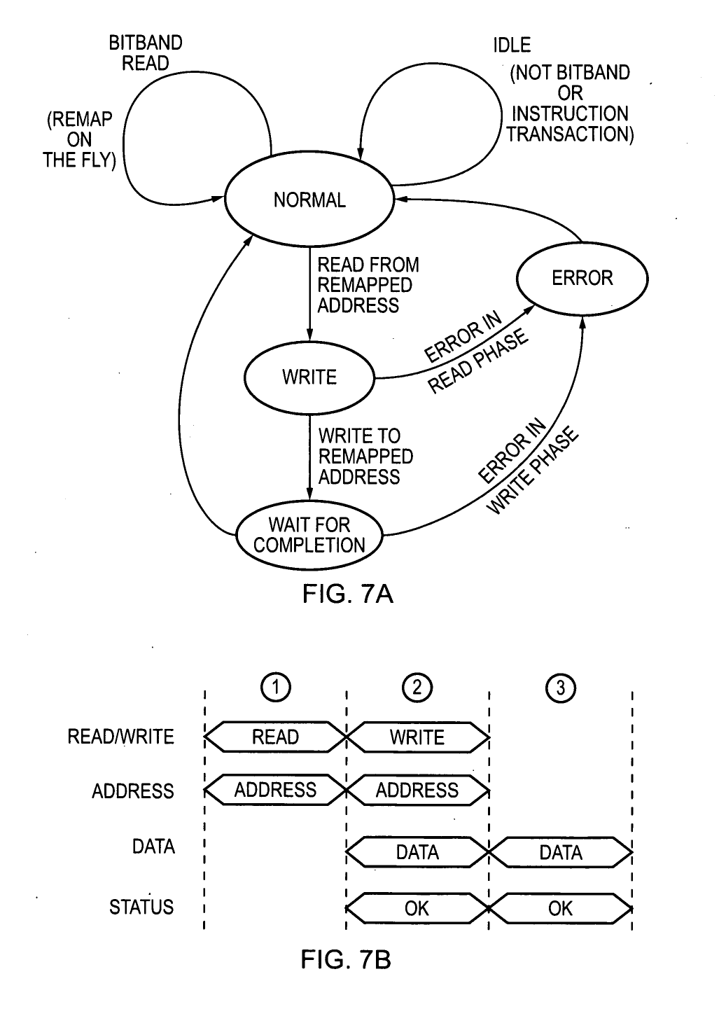

FIG. 7A schematically illustrates the states and state transitions of the finite state machine 210 shown in FIG. 6. In general the finite state machine defines the bit-band wrapper to be in a “normal” state from which an idle transition can occur (when an access request is either not a bit-band region related transaction or is an instruction transaction). When the bit-band wrapper is required to perform a bit-band read then the remapping occurs essentially “on-the-fly” and no state transition of the bit-band wrapper is required. However, if the bit-band wrapper is required to perform a bit-band write operation then the finite state machine causes the bit-band wrapper 200 to transition into a “write” state by first reading from the remapped address. If this read phase completes successfully then the finite state machine further transitions the bit-band wrapper into a “wait for, completion” state whilst the modified data value is rewritten into the bit-band region. If this completes without problems then the finite state machine returns the bit-band wrapper into its “normal” state. However if in either the read phase or the write phase an error occurs then the finite state machine transitions the bit-band wrapper into an “error” state (from which the occurrence of this error can be signalled to the bus master) before transitioning back to the “normal” state.

FIG. 7B schematically illustrates the relative timing of various signals which the data wrapper receives from and issues to the bus system. The illustrated example shows the signals when a bit-band write operation is carried out wherein in a first time cycle the bit-band wrapper issues a read request with a corresponding target memory address in a bit-band region. In a second memory period the bit-band wrapper issues a write access request with corresponding target address. Whilst the write request is being issued the data requested by the read access request is received along with a status indicator showing that this has completed successfully. Finally in the third time period, the data corresponding to the write process is transferred along with a corresponding status indicator. It should be noted that the timings illustrated correspond to an example implementation using the Advanced High-performance Bus (AHB) protocol of ARM Limited, in which the operations are pipelined such that the address and control information can be broadcast during the data phase of the previous transfer.

Although particular embodiments of the invention have been described herein, it will be apparent that the invention is not limited thereto, and that many modifications and additions may be made within the scope of the invention. For example, various combinations of the features of the following dependent could be made with the features of the independent claims without departing from the scope of the present invention.

We claim:

1. A data processing system comprising a bus master coupled to a bus slave via a bus system, wherein said bus master is configured to access said bus slave by issuing an access request, said access request being routed by said bus system to said bus slave, wherein said bus system comprises a data processing apparatus configured to act as an intermediary within said bus system, said data processing apparatus comprising:
an input configured to receive said access request issued by said bus master, said access request specifying a memory address in said bus slave;
an address comparator configured to determine an alias condition to be true if said memory address is within a predefined aliased memory region;
an address remapper configured, if said alias condition is true, to remap said memory address into an associated target memory address and a bit position within a target data value stored at said associated target memory address;
a request issuer configured to issue a remapped access request, said remapped access request causing said target data value to be read from said associated target memory address and to be returned to said data processing apparatus; and
a data handler configured to perform a data processing operation on said target data value at said bit position.

2. The data processing system as claimed in claim 1, wherein if said access request is a read access request, said data processing operation is a bit read operation configured to read a bit value at said bit position; and
said data processing apparatus is configured to return said bit value to said bus master.

3. The data processing system as claimed in claim 2, wherein said data processing apparatus is configured to return said bit value to said bus master by returning a read data value to said bus master, wherein said bit value is specified at a predetermined bit position in said read data value.

4. The data processing system as claimed in claim 3, wherein said data handler comprises a bit shifter configured to perform a bit shift operation on said target data value to align said bit value with said predetermined bit position in said read data value.

5. The data processing system as claimed in claim 1, wherein if said access request is a write access request, said data processing operation is a bit write operation configured to write a bit value at said bit position to generate a modified target data value; and
said request issuer is further configured to issue a write access request after said bit write operation has been performed, said write access request causing said modified target data value to be written at said associated target memory address.

6. The data processing system as claimed in claim 5, wherein said access request comprises a write data value and said bit value is specified at a predetermined bit position in said write data value.

7. The data processing system as claimed in claim 5, wherein said data handler comprises a bit shifter configured to perform a bit shift operation on said write data value to align said bit value with said bit position in said target data value.

8. The data processing system as claimed in claim 1, wherein said access request issued by said bus master specifies a data size;
said address remapper is configured to remap said memory address in dependence on said data size; and
said request issuer is configured to issue said remapped access request including said data size.

9. The data processing system as claimed in claim 1, wherein said data processing apparatus is further configured, if said access request is an instruction access request, to transmit said access request unmodified.

10. The data processing system as claimed in claim 1, wherein said data processing apparatus is configured to be positioned between said bus master and a common bus of said bus system.

11. The data processing system as claimed in claim 1, wherein said data processing apparatus is configured to be positioned between a common bus of said bus system and a target device hosting said associated target memory address.

12. The data processing system as claimed in claim 1, wherein said data processing apparatus is configured to be positioned between two common buses of said bus system.

13. The data processing system as claimed in claim 1, wherein said data processing apparatus is configured to indicate success of said data processing operation to said bus master.

14. The data processing system as claimed in claim 1, wherein said data processing apparatus is configured to indicate failure of said data processing operation to said bus master.

15. The data processing system as claimed in claim 1, wherein said data processing apparatus comprises a finite state machine configured to control operation of said data processing apparatus.

16. The data processing system as claimed in claim 5, wherein said request issuer is configured to broadcast a bus master lock when issuing said remapped access request, said bus master lock being asserted until completion of said write access request.

17. The data processing system as claimed in claim 1, wherein said associated target memory address is also accessible by a non-remapped access request.

18. The data processing system as claimed in claim 1, wherein said associated target memory address is hosted by a peripheral device, a memory or an I/O device.

19. The data processing system as claimed in claim 1, wherein said bus master is a processor core.

20. The data processing system as claimed in claim 1, wherein said bus master is a DMA controller.

21. A method of data processing in a data processing system comprising a bus master coupled to a bus slave via a bus system, wherein said bus master is configured to access said bus slave by issuing an access request, said access request being routed by said bus system to said bus slave, wherein said bus system comprises a data processing apparatus configured to act as an intermediary within said bus system, said method comprising the steps of:
receiving at said data processing apparatus an access request issued by a bus master, said access request specifying a memory address;
determining an alias condition to be true if said memory address is within a predefined aliased memory region;
if said alias condition is true, remapping said memory address into an associated target memory address and a bit position within a target data value stored at said associated target memory address;
issuing from said data processing apparatus a remapped access request, said remapped access request causing said target data value to be read from said associated target memory address and to be returned to said data processing apparatus; and
performing a data processing operation on said target data value at said bit position.

22. A data processing system comprising a bus master coupled to a bus slave via a bus system, wherein said bus master is configured to access said bus slave by issuing an access request, said access request being routed by said bus system to said bus slave, wherein said bus system comprises a data processing apparatus configured to act as an intermediary within said bus system, said data processing apparatus comprising:
input means for configured to receive an access request issued by a bus master, said access request specifying a memory address;
address comparison means for determining an alias condition to be true if said memory address is within a predefined aliased memory region;
address remapping means for, if said alias condition is true, remapping said memory address into an associated target memory address and a bit position within a target data value stored at said associated target memory address;
request issuing means for issuing a remapped access request, said remapped access request causing said target data value to be read from said associated target memory address and to be returned to said data processing apparatus; and
data handling means for performing a data processing operation on said target data value at said bit position.
